(19) United States
(12) Patent Application Publication
(10) Pub. No.: US 2024/0002091 A1
(43) Pub. Date: Jan. 4, 2024

(54) MANUFACTURING METHOD FOR TEA BAG FOLDING STRUCTURE

(71) Applicant: Yi-Pin TSENG, New Taipei City (TW)

(72) Inventor: Yi-Pin TSENG, New Taipei City (TW)

(73) Assignee: BIG INTELLIGENCE AUTOMATION CORP., New Taipei City (TW)

(21) Appl. No.: 18/027,046

(22) PCT Filed: Sep. 17, 2021
(86) PCT No.: PCT/CN2021/119136

§ 371 Date: Mar. 17, 2023

(30) Foreign Application Priority Data
Sep. 18, 2020 (CN) 202010988579.2

(51) Int. Cl. B65B 43/10; B65B 1/00; B65B 7/28; B65B 51/10; B65B 29/04

(52) U.S. Cl. CPC B65B 43/10; B65B 1/00; B65B 7/2878; B65B 51/10; B65B 29/04

(57) ABSTRACT

The invention discloses a manufacturing method for a tea bag folding structure comprising: a fold-to-overlap step and a press-to-fold step. The fold-to-overlap step is to overlap a sheet having a plurality of folding lines and join two opposite side edges thereof, and the press-to-fold step is to open the sheet into a hollow cylinder shape and fold the sheet into a cylindrical folding structure with openings at both ends along the plurality of folding lines. In the manufacturing method, after the tea bag folding structure is formed, one end opening of the tea bag folding structure is closed, the tea bag folding structure is filled with tea leaves, and the other end opening of the tea bag folding structure is closed.

### FIELD OF THE INVENTION

The present invention relates to a manufacturing method for a folding structure, and more particularly relates to a manufacturing method for a tea bag folding structure.

### BACKGROUND OF THE INVENTION

A tea bag is generally a bag-like structure which is filled with tea leaves and can be placed in water for brewing. For example, a patent, the patent No. CN203111819U discloses a “brewing article cladding structure”. Since the brewing article cladding structure is complex and is not easy to manufacture, developing manufacturing processes which can be produced in an automated or semi-automated manner is required.

### SUMMARY OF THE INVENTION

Therefore, one objective of the present invention is to provide a manufacturing method for a tea bag folding structure.

In order to overcome the technical problems in prior art, the present invention provides a manufacturing method for a tea bag folding structure, characterized by using a sheet having a plurality of folding lines, comprising: a fold-to-overlap step of folding the sheet to overlap the sheet, and thereafter joining two opposite side edges of the folded and overlapped sheet; and a press-to-fold step of, after the fold-to-overlap step, opening up the sheet into a hollow cylinder shape, and pressing the sheet along the plurality of folding lines of the sheet to form the sheet as a cylindrical folding structure, wherein two openings are formed along the sheet.

In one embodiment of the present invention, the manufacturing method further comprises an embossing step prior to the fold-to-overlap step, wherein in the embossing step, multiple rows of concave-and-convex structures are formed in the sheet, and the folding line is formed between each two rows of concave-and-convex structures.

In one embodiment of the present invention, the manufacturing method is provided, wherein in the fold-to-overlap step, a head end and a tail end which are the two opposite side edges of the sheet are connected to each other by folding, and the plurality of folding lines and the concave-and-convex structures are formed as rings by the connection between the head end and the tail end.

In one embodiment of the present invention, the manufacturing method is provided, wherein in the fold-to-overlap step, two of the sheets are stacked and cut to a predetermined length, and at cutting positions thereof, the sheets are connected to each other.

In one embodiment of the present invention, the manufacturing method is provided, wherein in the fold-to-overlap step, the sheet is opened into the hollow cylinder shape, and is folded radially inward along the plurality of folding lines to form the cylindrical folding structure.

In one embodiment of the present invention, the manufacturing method is provided, wherein in the fold-to-overlap step, the sheet is folded along the plurality of folding lines one by one to form the cylindrical folding structure.

In one embodiment of the present invention, the manufacturing method is provided, wherein in the fold-to-overlap step, the sheet is placed on a jig such that the sheet is opened into the hollow cylinder shape by the jig, and the jig includes a plurality of supporting elements, the plurality of supporting elements are driven to move away from each other to support the sheet from inside so as to open the sheet into the hollow cylinder shape and form an inner support when the sheet is folded from outside.

In one embodiment of the present invention, the manufacturing method is provided, wherein in the fold-to-overlap step, the jig includes the plurality of supporting elements which are arranged in a ring, the plurality of supporting elements are elongated and capable of opening the sheet into the hollow cylinder shape, the plurality of supporting elements have a jagged structure arranged axially in an outer surface of the supporting element, the sheet is folded into a jagged folding structure by means of the jagged structure.

The tea bag and the tea bag folding structure are completed by the steps mentioned above, and the manufacturing process mentioned above is performed in an automated or semi-automated manner by means of mechanical equipment. Thus, the present invention has beneficial effects on the manufacture of the tea bags having complex folding structure. In addition, the sheet is easy to be folded into a lantern-like folding structure by forming the concave-and-convex structures and the folding lines in the sheet.

### BRIEF DESCRIPTION OF THE DRAWINGS

Other features and effects of the present invention will be clearly presented in embodiments with reference to the drawings, wherein:

FIG. 1 is a flow chart illustrating a manufacturing method for a tea bag folding structure according to one embodiment of the present invention;

FIG. 2 is a schematic diagram illustrating an embodiment of the present invention for forming a tea bag folding structure into a tea bag;

FIG. 3 is a partial perspective view illustrating a sheet of the embodiment;

FIGS. 4A and 4B are schematic diagrams illustrating a fold-to-overlap step of the embodiment;

FIG. 5 is a schematic diagram illustrating another variation of the fold-to-overlap step;

FIGS. 6A to 6C are schematic diagrams illustrating a press-to-fold step of the embodiment;

FIG. 7 is a perspective view illustrating a jig and a clamp of the embodiment;

FIG. 8 is a schematic diagram illustrating that the sheet is opened by supporting elements in the embodiment; and

FIG. 9 is a schematic diagram illustrating a step of closing an opening at one end of the tea bag folding structure with a bottom cap and a step of filling tea leaves therein in the embodiment.

### DETAILED DESCRIPTION OF THE PREFERRED EMBODIMENTS

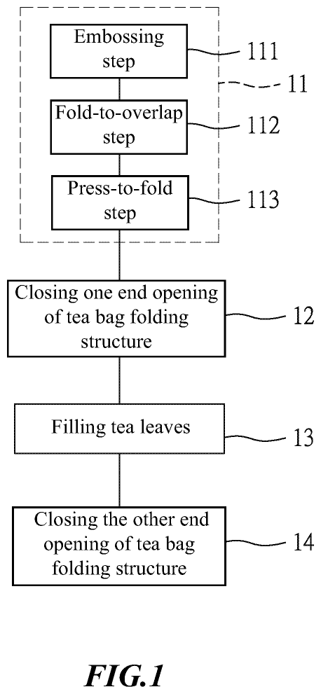

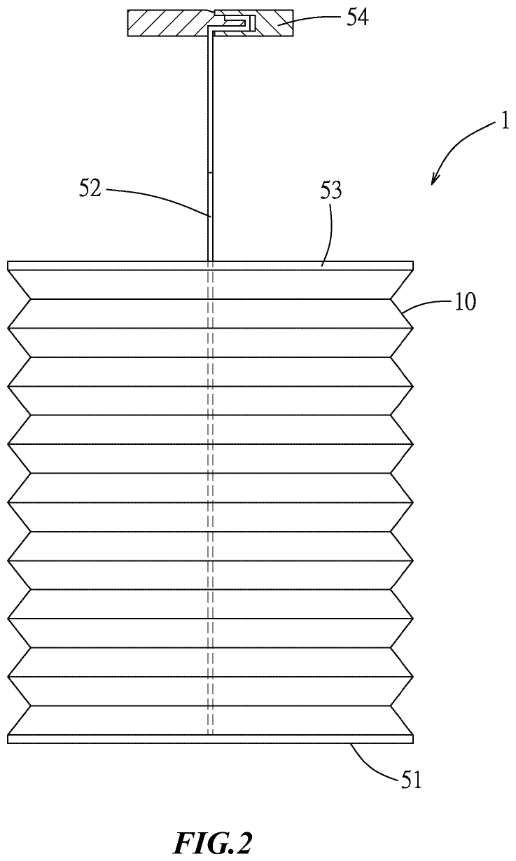

Referring to FIGS. 1 and 2, a manufacturing method for a tea bag folding structure according to one embodiment of the present invention is provided to manufacture a tea bag 1 having a lantern-like folding structure which can be stretched and compressed. The manufacturing method comprises the steps as follows.

A step 11: forming a tea bag folding structure 10 having a hollow cylinder shape and openings at both ends, as shown in FIG. 2, wherein the step 11 includes the sub-steps as follows.

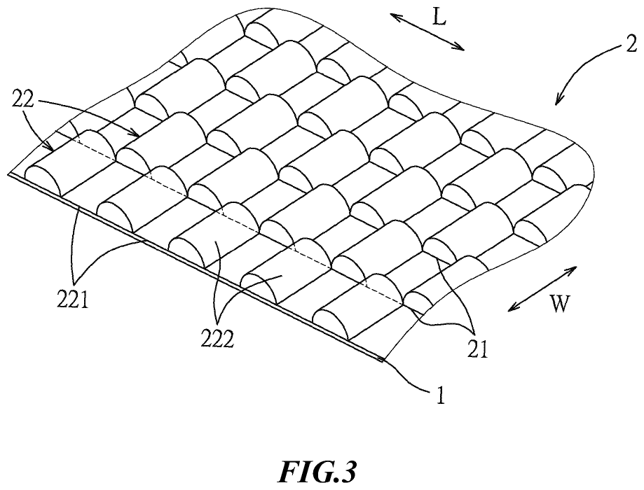

An embossing step 111: forming a plurality of embossing patterns in a sheet 1. The embossing step 111 can be performed by an embossing device. As shown in FIG. 3, in the embodiment, the embossing pattern includes a plurality of folding lines 21 and multiple rows of concave-and-convex structures 22. The multiple rows of concave-and-convex structures 22 are arranged along a width direction W, and each row of concave-and-convex structure is formed in a manner that a concave structure 221 and a convex structure 222 are alternatively arranged along a length direction L. Moreover, the folding line 21 extending along the length direction L is defined between each two rows of concave-and-convex structure 22 along the width direction W, and the folding lines 21 are spaced apart each other along the width direction W. The folding lines 21 are used to form a jagged folding structure, and the multiple rows of concave-and-convex structures 22 are used to assist the planar sheet 1 to be smoothly folded into the folding structure along the folding lines 21, as explained later. The embossing step 111 can also be performed directly by obtaining the sheet 1 having the folding lines 21.

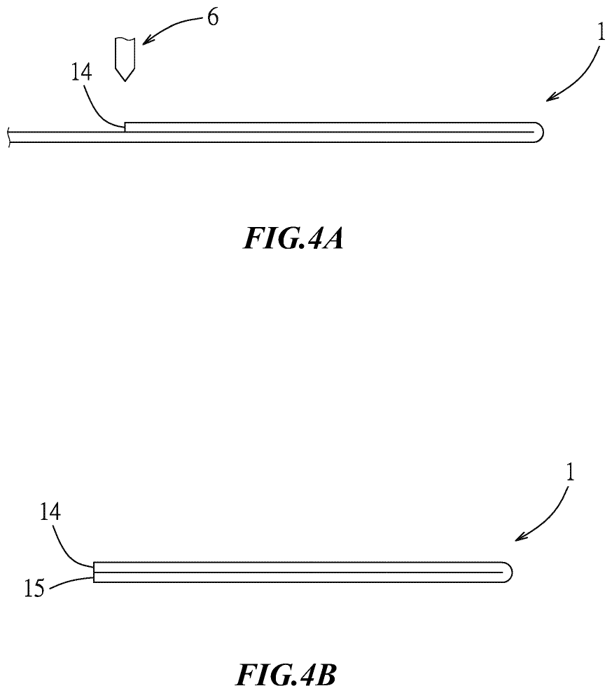

A fold-to-overlap step 112: folding the sheet 1 having the plurality of folding lines 21 to overlap the sheet 1, and thereafter joining two opposite side edges of the folded and overlapped sheet 1. The fold-to-overlap step 112 can be performed by a joining-and-cutting device 6. As shown in FIG. 4A, in the embodiment, the sheet 1 is manufactured by cutting a continuous elongated sheet in the step. In the cutting process, a head end 14 of the sheet 1 is reversely folded to form a folded structure and the sheet 1 is cut with the joining-and-cutting device 6, such as a thermal cutting device or an ultrasonic device. As shown in FIG. 4B, the sheet 1 is cut to form a folded shape, and the cut end defines a tail end 15. Moreover, the head end 14 and the tail end 15 which are the two opposite side edges of the sheet 1 are connected to one another by melting due to a high temperature or an ultrasonic frequency vibration during the cutting process. As a result, the cut sheet 1 is formed as a folded ring shape and can be opened from the center to form a hollow cylinder structure in which each row of concave-and-convex structure 22 and the folding lines 21 are also in ring shapes.

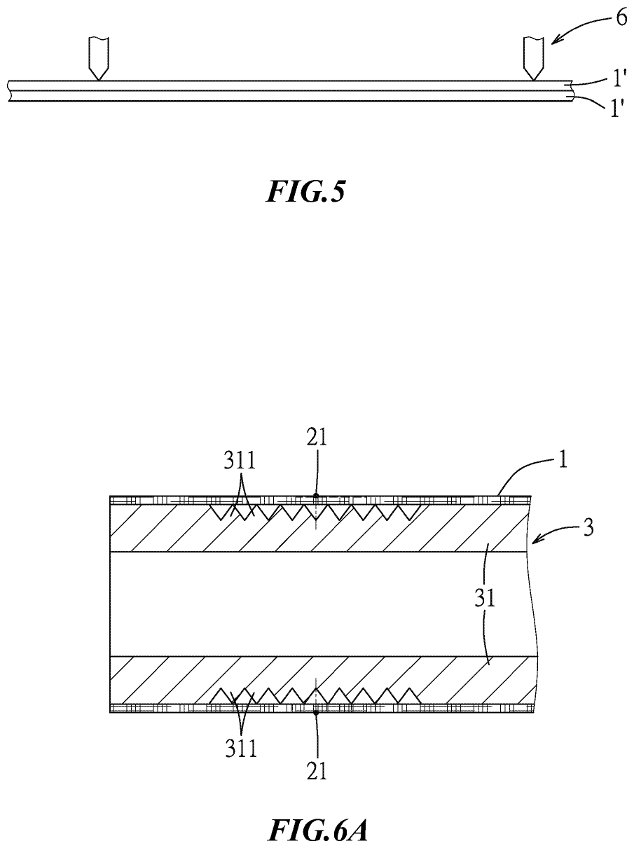

Referring to FIG. 5, in another embodiment of the fold-to-overlap step 112, two sheets 1′ are directly stacked to each other and are cut to a predetermined length by the joining-and-cutting device 6 such as the thermal cutting device or the ultrasonic device. Thereby, the two opposite side edges of the two sheets 1′ which are cut are connected to one another by melting due to a high temperature or an ultrasonic frequency vibration during the cutting process, wherein in the cutting process, the sheets 1′ are cut section by section by means of conveyor feeding.

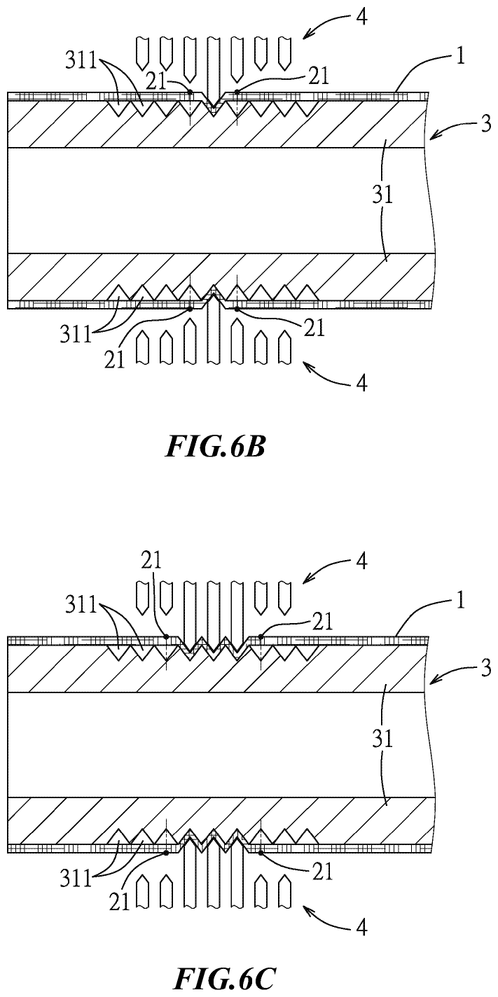

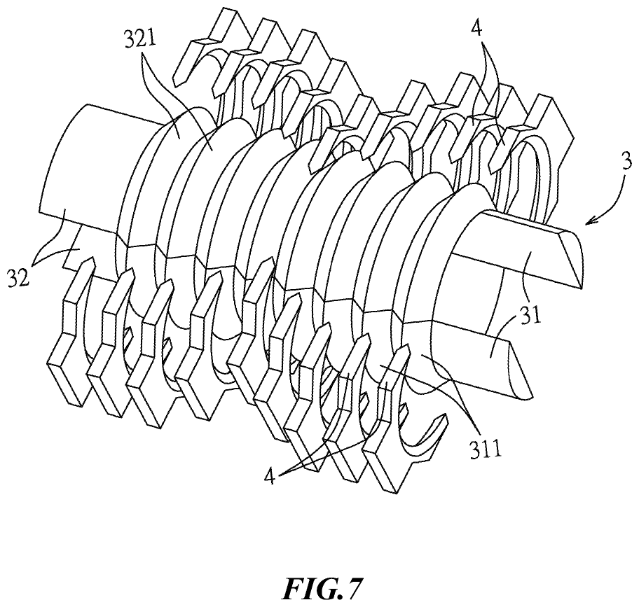

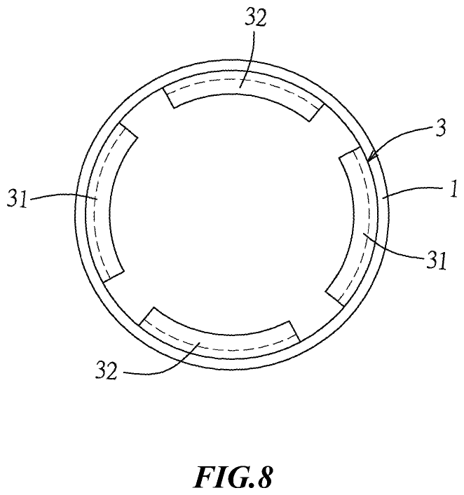

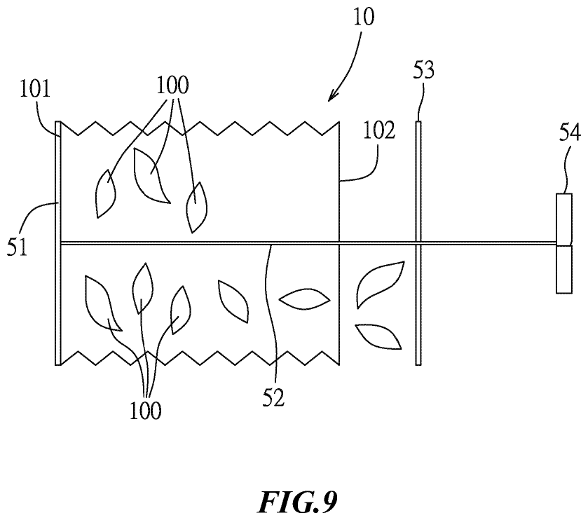

A press-to-fold step 113: after the fold-to-overlap step 112, opening up the sheet 1 into a hollow cylinder shape, and pressing the sheet 1 along the plurality of folding lines 21 of the sheet 1 to form the sheet 1 as the tea bag folding structure 10 with openings 101, 102 at both ends, as shown in FIG. 9. The press-to-fold step 113 can be performed by a folding device. As shown in FIGS. 6A, 7 and 8, in the press-to-fold step 113, the sheet 1 which has been stacked and folded is placed on a jig 3 such that the sheet 1 is opened into the hollow cylinder shape by the jig 3. In the embodiment, the jig 3 includes a plurality of supporting elements 31 which are arranged in a ring. The supporting elements 31 are elongated and capable of inserting into the sheet 1 to open the sheet 1 into the hollow cylinder shape. The supporting elements 31 can be driven to move close to each other and move away from each other along a radial direction. Moreover, the plurality of supporting elements 31, 32 have convex radial cross sections and have a jagged structure 311, 321 arranged axially in outer surfaces of the supporting elements 31, 32. The sheet 1 which has been stacked and folded is placed around the periphery of the supporting elements 31 and is thereby opened. Furthermore, the supporting elements 31, 32 are driven to move away from each other so that the outer surfaces of the supporting elements 31 having the jagged structure 311, 321, 32 support the sheets 1 from inside and form an inner support when the sheets 1 are folded from outside. In the embodiment, the number of the supporting elements 31, 32 is two, but the number of the supporting elements is not limited to this. Each of the supporting elements 31, 32 approximately corresponds to an area of 180 degree angle of the sheet 1, whereby the sheet 1 is opened into the hollow cylinder shape. In the embodiment, a plurality of folding element 4 are arranged at two opposite sides of the jig 3, so that the sheet 1 is disposed between the jig 3 and the folding element 4, and an outer surface of the folding element 4 facing toward the jig 3 is an inward concave curved shape.

In the press-to-fold step, as shown in FIG. 6A, firstly, one of the folding lines 21 located in center of the sheet 1 is aligned with one valley position of the jagged structure 311. Next, as shown in FIG. 6B, the centrally located folding element 4 is driven to inwardly push a portion of sheet 1 along the folding line 21 so that the sheet 1 is inwardly folded against the concave outer surface of the jagged structure 311 at the folding line 21. Next, as shown in FIG. 6C, the folding element 4 arranged at the two opposite sides of the jig 3 are driven to move inwardly to inwardly push the sheet 1 at another two folding lines 21 so that the pushed portions of the sheet 1 are inwardly folded against the concave outer surface of the jagged structure 311, and so on, to form a jagged folding structure one by one in the sheet 1. The purpose of forming the concave-and-convex structures 22 is that: since the sheet 1 is a planar structure, when the sheet 1 is folded along the folding lines 21, it is not easy to produce a uniform inwardly deformation without the formation of the concave-and-convex structures 22. Therefore, the pre-formation of the concave-and-convex structures 22 helps to deform the sheet 1 more smoothly when the sheet 1 is folded along the folding lines 21, and can prevent the sheet 1 from irregular or uncontrollable folding deformation. Moreover, as shown in FIG. 3, in the arrangement of a concave structure 221 and a convex structure 222 of the embodiment, in two rows of adjacent concave-and-convex structures 22, the concave structure 221 and the convex structure 222 are staggered from each other to form the spaced folding line 21, which is also helpful for the folding deformation of the sheet 1. After the press-to-fold step 113 is completed, the supporting elements 32 arranged at two opposite sides are driven to inwardly and oppositely displace to move away from inside of the sheet 1 and be retracted from the sheet 1. Next, the supporting elements 32 arranged at the other two opposite sides are also driven to inwardly and oppositely displace to move away from inside of the sheet 1 and be retracted from the sheet 1. In other alternating embodiment, the folding element 4 can also be a roller which rolls and presses along the folding line 21.

After the folding is completed, a lantern-like hollow cylinder shape with the tea bag folding structure 10 is formed. Moreover, the tea bag folding structure 10 has openings 101, 102 at both ends.

It should be noticed that in the press-to-fold step 113 of the embodiment, the folding element 4 presses against the sheet 1 along the folding lines 21 one by one from center to two side edges of the sheet 1, which prevents the sheet 1 from uncontrollable folding deformation; since the sheet 1 is pressed to fold from a plane to a folding structure which is with the concave structure and the convex structure in the press-to-fold process, pressing-and-folding along the folding lines 21 one by one can prevent the sheet 1 from a unintentional displacement or a rupture of the sheet 1 which results from multiple places receive forces in the meantime. Moreover, a folding sequence of the sheet 1 is preferably from the center of the sheet 1 which is bundled to the hollow cylinder shape to two ends of the sheet 1, or form one end of the sheet 1 which is the hollow cylinder shape to the other end of the sheet 1.

The processes from the step 111 to the step 113 mentioned above may also be completed in a series of embossing, stacking and cutting, and folding, using machine equipment in series as a production line.

Next, the following steps are performed to form the tea bag 1. A step 12: closing one end opening of the tea bag folding structure 10 by a bottom cap 51, wherein one end of a string is connected to the bottom cap 51. In the embodiment, as shown in FIG. 9, the bottom cap 51, the string 52 and a top cap 53 are combined in a manner that one end of the string 52 is connected to a middle of a surface of the bottom cap 51, the other end of the string 52 passes through a middle of the top cap 53 and is connected to the stopping rod 54. In this step, the bottom cap 51 seals opening 101 by means of a hot-press process, the string 52 passes through the tea bag folding structure 10, and the top cap 53 is located adjacent to the other end opening 102.

A step 13: filling tea leaves 100 in the tea bag. As also shown in FIG. 9, in this step, the tea leaves 100 are filled into the tea bag folding structure 10 from the opening 102. At this time, since the bottom cap 51 seals the opening 101, the tea leaves 100 will not fall out.

A step 14: after the tea leaves 100 are filled in the tea bag, the top cap 53 is connected to the tea bag folding structure 10 to close the other end opening 102 by means of a hot-press process, wherein the other end of the string 52 passes through the top cap 53 and is connected to the stopping rod 54. Thus, the manufacture of tea bag as shown in FIG. 2 is completed.

Summarize the above, the present invention completes the manufactures of the tea bag folding structure 10 and the tea bag 1 by the steps mentioned above, and performs the process mentioned above in an automated or semi-automated manner by means of mechanical equipment. Thus, the present invention has beneficial effects on the manufacture of the tea bags having complex folding structure, indeed can achieve the purpose of the present invention.

In addition, the present invention folds the sheet 5 along the folding lines 21 into the cylinder-shape folding structure mainly by the formation of the folding lines 21 and the concave-and-convex structures 22 of the sheet 1 and by using the jig 3 and the folding element 4. The fold-to-overlap step mentioned above is not limited to the manner and the embodiment disclosed in FIGS. 4A, 4B and 5.

What is claimed is:

1. A manufacturing method for a tea bag folding structure, characterized by using a sheet having a plurality of folding lines, comprising:
a fold-to-overlap step of folding the sheet to overlap the sheet, and thereafter joining two opposite side edges of the folded and overlapped sheet; and
a press-to-fold step of, after the fold-to-overlap step, opening up the sheet into a hollow cylinder shape, and pressing the sheet along the plurality of folding lines of the sheet to form the sheet as a cylindrical folding structure, wherein two openings are formed along the sheet.

2. The manufacturing method as claimed in claim 1, further comprising an embossing step prior to the fold-to-overlap step, wherein in the embossing step, multiple rows of concave-and-convex structures are formed in the sheet, and the folding line is formed between each two rows of concave-and-convex structures.

3. The manufacturing method as claimed in claim 2, wherein in the fold-to-overlap step, a head end and a tail end which are the two opposite side edges of the sheet are connected to each other by folding, and the plurality of folding lines and the concave-and-convex structures are formed as rings by the connection between the head end and the tail end.

4. The manufacturing method as claimed in claim 2, wherein in the fold-to-overlap step, two of the sheets are stacked and cut to a predetermined length, and at cutting positions thereof, the sheets are connected to each other.

5. The manufacturing method as claimed in claim 3, wherein in the fold-to-overlap step, the sheet is opened into the hollow cylinder shape, and is folded radially inward along the plurality of folding lines to form the cylindrical folding structure.

6. The manufacturing method as claimed in claim 4, wherein in the fold-to-overlap step, the sheets are opened into the hollow cylinder shape, and are folded radially inward along the plurality of folding lines to form the cylindrical folding structure.

7. The manufacturing method as claimed in claim 5, wherein in the fold-to-overlap step, the sheet is folded along the plurality of folding lines one by one to form the cylindrical folding structure.

8. The manufacturing method as claimed in claim 6, wherein in the fold-to-overlap step, the sheets are folded along the plurality of folding lines one by one to form the cylindrical folding structure.

9. The manufacturing method as claimed in claim 5, wherein in the fold-to-overlap step, the sheet is placed on a jig such that the sheet is opened into the hollow cylinder shape by the jig, and the jig includes a plurality of supporting elements, the plurality of supporting elements are driven to move away from each other to support the sheet from inside so as to open the sheet into the hollow cylinder shape and form an inner support when the sheet is folded from outside.

10. The manufacturing method as claimed in claim 6, wherein in the fold-to-overlap step, the sheets are placed on a jig such that the sheets are opened into the hollow cylinder shape by the jig, and the jig includes a plurality of supporting elements, the plurality of supporting elements are driven to move away from each other to support the sheets from inside so as to open the sheets into the hollow cylinder shape and form an inner support when the sheets are folded from outside.

11. The manufacturing method as claimed in claim 9, wherein in the fold-to-overlap step, the jig includes the plurality of supporting elements which are arranged in a ring, the plurality of supporting elements are elongated and capable of opening the sheet into the hollow cylinder shape, the plurality of supporting elements have a jagged structure arranged axially in an outer surface of the supporting element, the sheet is folded into a jagged folding structure by means of the jagged structure.

12. The manufacturing method as claimed in claim 10, wherein in the fold-to-overlap step, the jig includes the plurality of supporting elements which are arranged in a ring, the plurality of supporting elements are elongated and capable of opening the sheets into the hollow cylinder shape, the plurality of supporting elements have a jagged structure arranged axially in an outer surface of the supporting element, the sheets are folded into a jagged folding structure by means of the jagged structure.
